(19) United States
(12) Patent Application Publication
(10) Pub. No.: US 2005/0283727 A1
(43) Pub. Date: Dec. 22, 2005

(54) Non-resident methods and systems for providing clickless user actuation of a webpage

(76) Inventor: William Thomas Large, Mineola, NY (US)

Correspondence Address: JENNIFER MEREDITH;MEREDITH & KEYHANI, PLLC, 330 MADISON AVE., 6TH FLOOR, NEW YORK, NY, 10017, US

(21) Appl. No.: 10/872,602

(22) Filed: Jun. 21, 2004

(51) Int. Cl. G06F 3/00; G06F 17/30

(52) U.S. Cl. 715/711; 715/715; 715/857; 707/4

(57) ABSTRACT

The present invention provides methods and systems for clickless user actuation of a webpage through a non-resident application. The non-resident application provides clickless web browsing by determining the position of a user-controlled pointer, displaying an indicator on the computer display corresponding to an active region and actuating the user controlled pointer after a period of activity to provide for server side clickless web browsing.

### BACKGROUND OF THE INVENTION

The Internet, or World Wide Web could be believed to be the most used computer application in the world as it has billions of pages of accessible information that may be accessed by anybody with a computer and an Internet connection. It could arguably be stated that the use of the Internet has already created more use of human finger activity, in clicking mouse buttons and buttons on other input devices that all other activities involving mans use of fingers in the history of the world so far.

By reasonable analysis it can be anticipated that use of the Internet for business or hobby purposes can require the users to click at click count rates between 100 and 1000 (peak) times per hour which is a physical load in excess of other compute input usage in non Internet application. It is therefore possible to accumulate a click count total of over 1000000 times per year by searching the Internet for less that an average of 3 hours a day.

Best available data analysis suggests that as of September 2002 there were 606.8 million people online and estimates by Nielson for March 2004 suggested that 26 hrs, 11 minutes and 14 seconds is the average time spent online by users who on average spent 46 seconds at each page visited. If it is assumed that this same online user clicks once per page viewed and then it is likely that, world-wide, mouse buttons are clicked some 1,269,338,000,000 or 1.3 Trillion times, equivalent to a rate of nearly 500,000 times a second.

It is now well documented that computer usage and mousing work in particular creates functional impairment in an increasing number of people. For persons with disabilities, which also includes those limitations and chronic conditions that come about due to the aging process, it is frequently difficult or impossible for them to have the manual dexterity to invoke the input that will provide them with access to Internet information they make seek. Research commissioned by the Microsoft Corporation and disclosed on their website (www.microsoft.com/enable/research) suggests that 1 in 4 computer users between the ages of 18 and 64 have impairments that limit their dexterity. Of these some 24.4M are anticipated as “likely” to require assistance and a further 6.8M “very likely” to require assistance with products that overcome their physical limitations, The present invention alleviates the need to actively invoke physical mouse functions such as mouse clicking.

The present invention provides a software application that invokes the hardware utility of clicking interactive portions of the screen when in an Internet navigating application such as, but not limited to Microsoft Internet Explorer, Netscape or Mozilla. The process of automatically clicking mouse buttons has until now been limited to proprietary software that each user thereof must download and install on their own machines.

The present invention is a software utility process embedded within an Internet Service Providers (ISP) software removing the need for the end user to manually actuate an input function on an Internet site and so remove the need to physically click, or click and hold down mouse buttons so as to drag the “scroll tab” or use a scroll wheel to view text or page content that is beyond the screen horizon, or perform such other functions that could be required to be performed by those able to do so or are unavailable to those who are not able to do so. By this fact that this invention does not discriminate between users by its use it is classified as Universally Assistive Technology. Likewise it is technology that complies with the US Government's Standards under Section 508 of the 1998 Rehabilitation act as within that standard, Desktop and Portable Computers (1194.26) Updated: Aug. 1, 2001 Subsection: (2) Controls and keys shall be operable with one hand and shall not require tight grasping, pinching, or twisting of the wrist. The force required to activate controls and keys shall be 5 lbs. (22.2 N) maximum. As there is no zero force required to “activate the controls”.

Previous attempts to solve this problem have often been difficult to implement. U.S. Pat. No. 6,563,514 issued to Samar, discloses a software program that configures a computer system on which it executes to access information as opposed to exercising control over an item over which a pointer has hovered for a preset time without the user having to provide any additional inputs. Unlike the present invention the Samar system must be loaded onto an end users computer, and works only thereon. The present invention, in contrast, is non-resident, does not require installation and may be loaded onto an Internet Service Provider system or a domain Host, allowing all visitors to associated websites to utilize the click-less functionality. The present invention allows for software mediated clicking utility by any visitor to any website so enabled without the complexity of downloading the program and storing it on their computer. Samar is also lacking in that it does not anticipate disability or variability in user reactions to provide an adjusted time period to suit such variability. As such, it is cumbersome, fixed and difficult to implement.

U.S. Pat. No. 6,664,990 issued to Bates, et al. discloses a computer system and method of performing a second chance pointer operation, wherein a pointer displayed on a computer display includes at least one alternative hotspot. Unlike the present invention, the Bates invention still requires manual clicking of the mouse buttons to perform the functions of the software system.

By removing the need to click mouse buttons at a time when many users are gripping a computer mouse in order to search the Internet it will dramatically reduce the likelihood of aches, pains, injury and impairment that is now associated with the use of the computer mouse, as well as empower those who disabled by providing them with fully functional and finger activity free access to the Internet. The system can also anticipate the needs of others who do not have the benefit of sight by providing other outputs, for instance but not limited to, audio and tactile stimuli to indicate or describe the location of the mouse cursor on the screen and offer alternative input control options as would be logical for the use and enjoyment of Internet mediated interactions.

### SUMMARY OF THE INVENTION

The present invention relates to clickless actuation systems and methods. It is used to provide easy, clickless web browsing and document browsing. In this manner, repetitive injuries are avoided and easy computer use is facilitated.

A method of selecting and actuating a computer input displayed on a user interface using a user controlled pointer, the method comprising the steps of: providing a non-resident code application for managing user interface action; embedding the non-resident code application in a document having active regions, each active region having a corresponding item; determining the position of a user-controlled pointer displayed on a user interface; displaying an indicator on the computer display when the user-controlled pointer coincides with the active region; actuating the user controlled pointer after a period of inactivity by the user; and displaying the corresponding item on the user interface.

A method of selecting and actuating a computer input displayed on a user interface using a user controlled pointer, the method comprising the steps of: providing a non-resident code application for managing user interface action; embedding the non-resident code application in a server-side document having active regions, each the active region having a corresponding item; initiating a user session; determining the position of a user-controlled pointer displayed on a user interface; displaying a colored circle shaped indicator on the computer display when the user-controlled pointer coincides with the active region for a period of time, the colored circle shaped indicator displayed being specific to the function of the active region; actuating the user controlled pointer after a period of inactivity by the user; and displaying the corresponding item on the user interface.

A system configured to select a graphical display element corresponding to an active region using a user-controlled pointing device, comprising: a server side memory containing a document having non-resident code therein, the non-resident code configured to display an indicator when the user-controlled pointing device is pointing to an active region having a corresponding item and to actuate the pointing device after a period of inactivity to provide the corresponding item.

These and other advantages and features, which characterize the invention, are set forth in the claims annexed hereto and forming a further part therof. However, for a better understanding of the invention, and of the advantages and objectives attained through its use, reference should be made to the Drawings, and to the accompanying descriptive matter, in which there are described exemplary embodiments of the invention.

### BRIEF DESCRIPTION OF THE DRAWINGS

FIG. 1 depicts a system according to the present invention;

FIG. 2 depicts a web page according to the present invention;

FIG. 3 depicts a flowchart according to the present invention; and

FIG. 4 depicts a flowchart according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

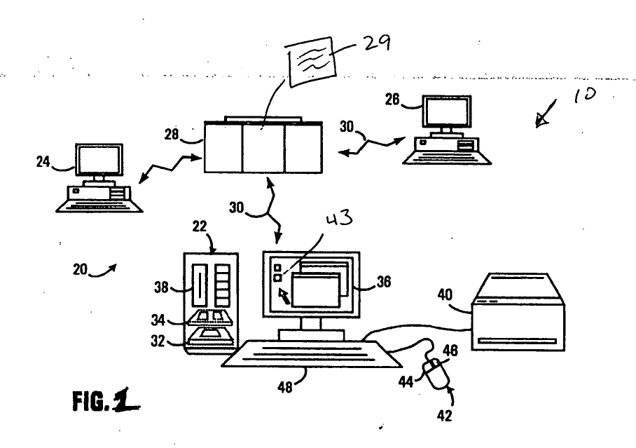

The present invention envisions systems and methods for providing clickless actuation. FIG. 1 depicts a computer system 20 consistent with the present invention. Computer system 20 is illustrated as a networked computer system including one or more client computer systems 22, 24 and 26 (e.g., desktop or personal computers, workstations, etc.) coupled to server system 28 through a network 30. Network 30 may represent practically any type of networked interconnection, including but not limited to local-area, wide-area, wireless, and public networks (e.g., the Internet). Moreover, any number of computers and other devices may be networked through network 30, e.g., multiple servers. Furthermore, it should be appreciated that the principles of the invention may be utilized as well by stand-alone computers and associated devices consistent with the invention.

Computer system 22, which may be similar to computer systems 24, 26, and may include a processor such as a microprocessor 32; a memory 34; a number of peripheral components such as a computer display 36; storage devices 38 such as hard, floppy, and/or CD-ROM disk drives; a printer 40; user-manipulated pointing devices such as a mouse 42 having a left button 44 and right button 46; and a keyboard 48, among others. As is well known within the art, pointing devices have an associated graphical display element 43 on the computer display 36 which has a corresponding active region, e.g. a Hyperlink. Computer system 22 operates under the control of an operating system, and executes various computer software applications, programs, objects, modules, etc. Moreover, various applications, programs, objects, modules, etc. may also execute on one or more processors in server 28 or other computer systems 24, 26, e.g., in a distributed computing environment. Generally, the web browser and/or other applications run on the clients computer systems (24, 26, e.g.), while web pages and information being browsed generally resides on the servers 28. While a client computer system 24, 26 may act as a server 28, it is generally understood that the present invention, as opposed to the prior art, is intended to be software or code that resides on the server side. As such, there is no requirement for client computer system plug-ins or downloading software.

Computer display 36 may include any known manner of visual or tactile presentation of information to a user. For example, computer display 36 may be a video monitor, e.g., a cathode-ray tube (CRT), a liquid crystal display (LCD), or a projection display, among others. In addition, other types of computer displays, including two-dimensional displays that simulate three dimensions (e.g., virtual reality headsets), as well as three-dimensional displays such as holographic tanks and the like, may also be used.

User input may also be received from other known user input devices. For example, control of a pointer on a display may be handled by a trackball, a joystick, a light pen, a touch sensitive pad or display, a digitizing tablet, and a keyboard, among others. In addition, many of such devices include one or more user controls such as buttons, thumb wheels, sliders and the like. Moreover, voice and/or image recognition may be used to permit a user to provide voice commands and/or gestures to provide user input to a computer system. Other user interface devices may also be used in the alternative. Control of a pointer on a display may be handled by a trackball, a joystick, a light pen, a touch sensitive pad or display, a digitizing tablet, and a keyboard, among others.

According to one embodiment, the system 10 is configured to allow the user to select a graphical display element 43 corresponding to an active region using a user-controlled pointing device 42. The server side memory 28 contains a document 29 having non-resident code therein. The non-resident code may be written in a number of different languages, including ActiveX and/or java script and is configured to display an indicator on the users computer display 36 when the user-controlled pointing device 42 is pointing to an active region having a corresponding item and to actuate the pointing device 42 after a period of inactivity to provide the corresponding item. The indicator may be a shape, sound, or sensation. The period of activity may be set by the end user, a system administrator or domain host. The corresponding item may be Hyperlinks, back icons, forward icons, save icons and scroll bars, search, email, print and other menu draw down and menu item selection functions. After actuation the program may reactivate, or reset, to allow actuation again. The program may also be programmed to reactivate when the user controlled pointer is moved in any direction beyond a defined number of pixels from a starting pixel point.

It is also envisioned that the program may be programmed to disable the input device after a disable time period. The present invention may also provide for an adjustment in screen size, anywhere on the display including around the indicator, to increase pointability in an area surrounding the pointer.

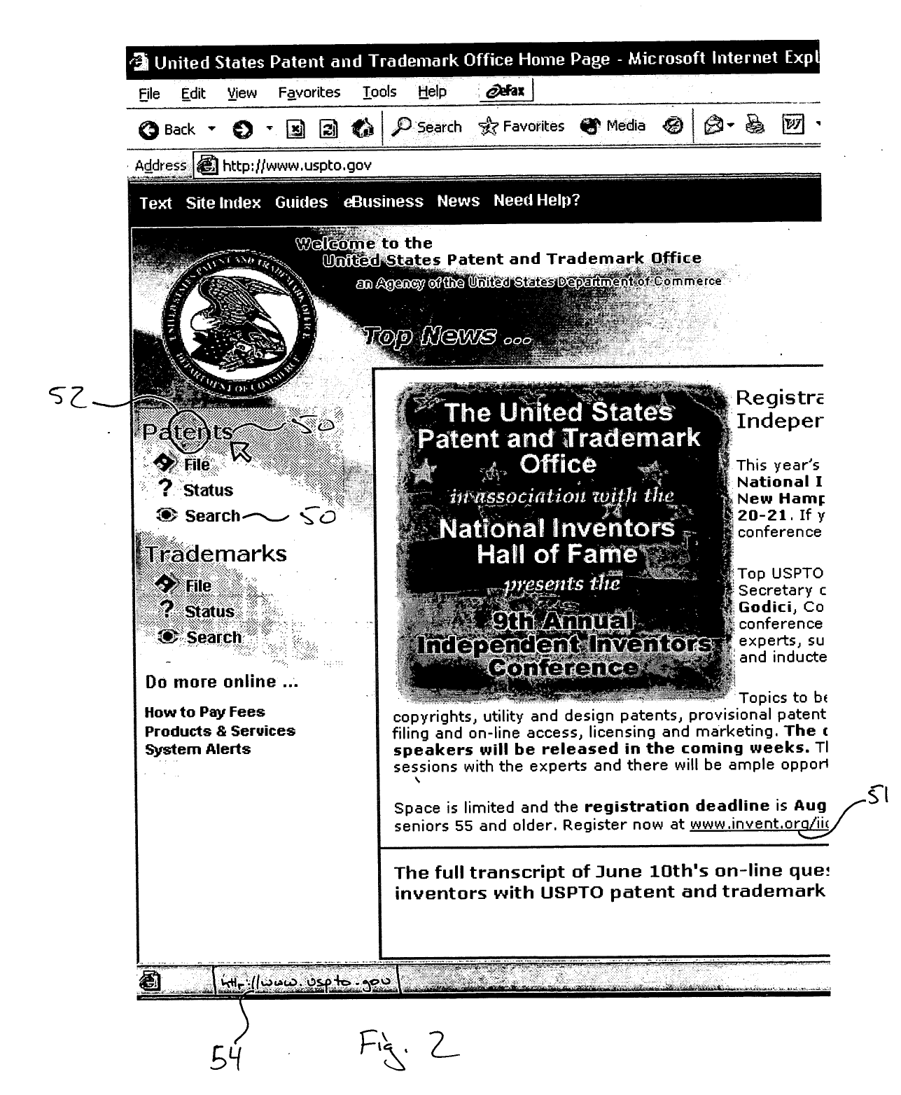

FIG. 2 depicts the present invention according to a preferred embodiment. The indicator 52 is preferably a color coded circle, and after a period of inactivity, the program automatically actuates to provide the requested corresponding item. The indicator 52 is also preferably translucent and may display the destination of the Hyperlink (i.e. the address).

The invention recognizes specific regions of the graphics environment of the computer screen and by that recognition is able to interrogate and interpret individual user interactive regions 50 such as Hyperlinks 51, “back, forward, save icons” By interrogation it can detect such regions 50 as scroll bars so as to allow them to be “dragged” by which the contents of the page can be moved up and down the screen in cases where the page itself is too big for the screen display. The utility is unique in that different colors and shapes (prompts) are displayed at the screen display. The utility is unique in that different colors and shapes are displayed at the screen cursor to indicate to the user the specific function the utility is providing, such as a red circle when a Hyperlink 51 is about to be actuated or a blue circle when a drag function can be activated. Further still the utility provides for user selection of functionality as to how long the prompt will be displayed for before the action indicated by the prompt will be actuated. The purpose and benefit so provided, when the user observes a red circle over a Hyperlink prompt 51, is the opportunity to inspect the coordinates of that Hyperlink by reading them in the status bar 54 (as labeled in Microsoft Internet Explorer) or equivalent browser region. By being able to alter the time from whence the red circle first appears, when the screen cursor is placed over the Hyperlink 51, to when it disappears indicating the connection to the Hyperlink 51 has been attempted, allows users with varying degrees of skill and reaction time to optimize their activity and avoid accidental linkage.

The utility of being able to monitor time spent on the Internet so as to prompt users to take a break subscribes to good computer practice as stretching or movement are recommended to keep the circulation system moving and to avoid possible consequences that maintaining a static posture for long periods represents. The BBC in the UK recently reported a case of Deep Vein Thrombosis, a blood clot in the leg of an individual, which was entirely attributed to the consequence of static posture after spending many hours at a time on the Internet. This monitoring capability also offers the utility of disabling the mouse and the keyboard for the duration of the Break that the user has chose so as to ensure that such stretching or movement is more likely to be performed. Like wise this disable keyboard and mouse utility could equally be applied to inhibiting the ability of the user to visit certain websites either by specific name or by some other means or only allowing access to specific named sites. In this way it provides the capability to supervise and manage the Internet access of the user. Such supervisors may be but are not limited to, Parents and or Administrators. moving a screen cursor and indicating an interest or desire to display the information available by clicking upon a link such as a Hyperlink, to display the information by clicking or manually actuating an electromechanical input device of numerous designs or by actuation of some means other means including software resident on the users computer that will have required downloading and installation or by some other method that is within and specific to the user computer.

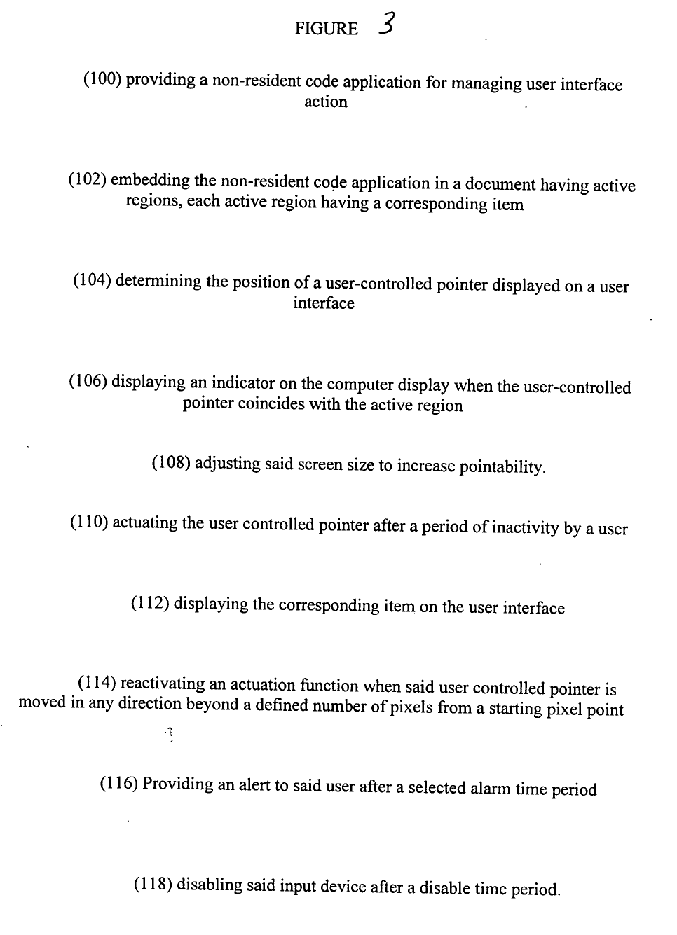

As depicted in FIG. 3, according to a preferred embodiment, a method of selecting and actuating a computer input displayed on a user interface (e.g. 36) using a user controlled pointer (e.g. 43) is disclosed, the method comprising the steps of: (100) providing a non-resident code application for managing user interface action. The term non-resident code application means that the code application does not reside on the clients or user computer. Rather, the code application resides on the server 28 containing the documents. In this manner, companies may create web pages that automatically have the clickless webpage. Users do not need to load any special software or plug-ins. Companies and web page authors merely create the web pages with the code application therein. The application may be written in ActixeX, or java script, etc. Step 102 embedding the non-resident code application in a document 31 having active regions 33, each active region 33 having a corresponding item. The corresponding item may be Hyperlinks, back icons, forward icons, save icons and scroll bars, search, email, print and other menu draw down and menu item selection functions. Step 104 determining the position of a user-controlled pointer 43 displayed on a user interface 36. Step 106 displaying an indicator 50 on the computer display 36 when the user-controlled pointer 43 coincides with the active region 33. The indicator 50, according to a preferred embodiment is a color coded circle. However, the indicator may be a number of different indicators including different shapes, colors, sensations, and audio and visual inputs. Step 108 adjusting the screen size to increase pointability. For example, the indicator may be a circle and the circle may be a translucent color and increase the font of the writing of the content behind the circle. The indicator is depicted by colors, shapes, sensations and sounds and is generally specific to the function of the active region. The indicator may be translucent, to allow viewing of the contents on the web page or document behind the circle, shape, color, etc. There may also be the Hyperlink written over or behind the indicator. For example, a light colored Hyperlink address http://www.meredithkeyhani.com. Step 110 actuating the user controlled pointer after a period of inactivity by a user. The period of inactivity required for actuation may be defined by the end user, a system administrator or domain host and may be dynamically adaptable to the users proficiency and/or configured by the end user, system administrator or domain host. Step 112 displaying the corresponding item on the user interface. Step 114 reactivating an actuation function when the user controlled pointer is moved in any direction beyond a defined number of pixels from a starting pixel point. Step 116 providing an alert to the user after a selected alarm time period; Step 118 disabling the input device after a disable time period. The disable time period may be selected by a user or administrator. Step 120 providing a choreographed movement of the user-controlled pointer; and Step 122 performing a function on the choreographed movement by a user manipulated pointing device. The nonresident code application resides on the Internet Service Provider system or the document's host computer. The step of actuating may also be a step of actuating a non-actuating movement. That is to say, that the program may recognize that the user does not want to actuate and therefore not actuate the pointing device.

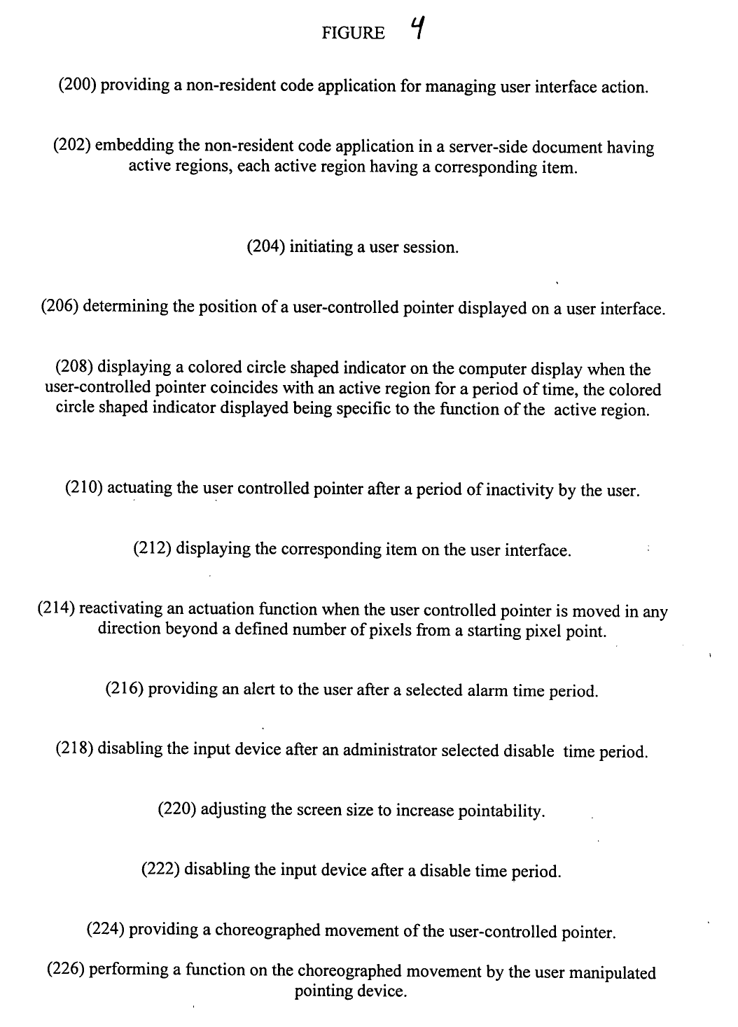

According to another embodiment, a method of selecting and actuating a computer input displayed on a user interface using a user controlled pointer is depicted in FIG. 4. The method may have a first step 200 providing a non-resident code application for managing user interface action. Step 202 embedding the non-resident code application in a server-side document having active regions, each active region having a corresponding item. The corresponding item may be a Hyperlink, back icons, forward icons, save icons and scroll bars, search, email, print and other menu draw down and menu item selection functions. Step 204 initiating a user session. Step 206 determining the position of a user-controlled pointer displayed on a user interface. Step 208 displaying a colored circle shaped indicator on the computer display when the user-controlled pointer coincides with an active region for a period of time, the colored circle shaped indicator displayed being specific to the function of the active region. The colored circle-shaped indicator may also have a sound and may be translucent, and may have the destination of the Hyperlink translucently displayed over the circle shaped colored indictor. Step 210 actuating the user controlled pointer after a period of inactivity by the user. The period of inactivity may be dynamically adaptable to the users proficiency or configured by the end user, system administrator or domain host. Step 212 displaying the corresponding item on the user interface. Step 214 reactivating an actuation function when the user controlled pointer is moved in any direction beyond a defined number of pixels from a starting pixel point. Step 216 providing an alert to the user after a selected alarm time period. Step 218 disabling the input device after an administrator selected disable time period. Step 220 adjusting the screen size to increase pointability. Step 222 disabling the input device after a disable time period. Step 224 providing a choreographed movement of the user-controlled pointer. Step 226 performing a function on the choreographed movement by the user manipulated pointing device.

1. A method of selecting and actuating a computer input displayed on a user interface using a user controlled pointer, said method comprising the steps of:
providing a non-resident code application for managing user interface action;
embedding said non-resident code application in a document having active regions, each said active region having a corresponding item;
determining the position of a user-controlled pointer displayed on a user interface;
displaying an indicator on said computer display when said user-controlled pointer coincides with said active region;
actuating said user controlled pointer after a period of inactivity by said user; and
displaying the corresponding item on said user interface.

2. A method as in claim 1, wherein said non-resident code application is written in ActixeX.

3. A method as in claim 1, wherein said non-resident code application is written in java script.

4. A method as in claim 1, wherein said non resident code application resides on the Internet Service Provider system.

5. A method as in claim 1, wherein said non-resident code application resides on said document's host computer.

6. A method as in claim 1, wherein said corresponding item is selected from the group consisting of Hyperlinks, back icons, forward icons, save icons and scroll bars, search, email, print and other menu draw down and menu item selection functions.

7. A method as in claim 1, wherein said indicator is depicted by colors, shapes, sensations and sounds.

8. A method as in claim 1, wherein indicator displayed is specific to the function of said active region.

9. A method as in claim 1, wherein said period of inactivity is defined by the end user, a system administrator or domain host.

10. A method as in claim 1, further comprising the step of:
Providing an alert to said user after a selected alarm time period.

11. A method as in claim 1, further comprising the step of:
disabling said input device after a disable time period.

12. A method as in claim 1, further comprising the step of:
disabling said input device after a administrator selected time period.

13. A method as in claim 1, further comprising the step of:
adjusting said screen size to increase pointability.

14. A method as in claim 1, further comprising the step of:
reactivating an actuation function when said user controlled pointer is moved in any direction beyond a defined number of pixels from a starting pixel point.

15. A method as in claim 1, wherein said indicator is translucent.

16. A method as in claim 1, wherein said indicator is the destination of said Hyperlink.

17. A method of as in claim 1, wherein said period of inactivity is dynamically adaptable to the users proficiency.

18. A method as in claim 1, wherein said period of inactivity is configured by the end user, system administrator or domain host.

19. A method as in claim 1, further comprising the steps of:
providing a choreographed movement of said user-controlled pointer; and
performing a function on said choreographed movement by said user manipulated pointing device.

20. A method as in claim 1, wherein said step of actuating is non-actuating.

21. A method of selecting and actuating a computer input displayed on a user interface using a user controlled pointer, said method comprising the steps of:
providing a non-resident code application for managing user interface action;
embedding said non-resident code application in a server-side document having active regions, each said active region having a corresponding item;
initiating a user session;
determining the position of a user-controlled pointer displayed on a user interface;
displaying a colored circle shaped indicator on said computer display when said user-controlled pointer coincides with said active region for a period of time, said colored circle shaped indicator displayed being specific to the function of said active region;
actuating said user controlled pointer after a period of inactivity by said user; and
displaying the corresponding item on said user interface.

22. A method as in claim 21, wherein said non-resident code application is written in ActixeX.

23. A method as in claim 21, wherein said non-resident code application is written in java script.

24. A method as in claim 21, wherein said corresponding item is selected from the group consisting of Hyperlinks, back icons, forward icons, save icons and scroll bars, search, email, print and other menu draw down and menu item selection functions.

25. A method as in claim 21, wherein said colored circle-shaped indicator is further comprised of a sound.

26. A method as in claim 21, wherein said period of inactivity is defined by the end user, a system administrator or domain host.

27. A method as in claim 21, further comprising the steps of:
reactivating an actuation function when said user controlled pointer is moved in any direction beyond a defined number of pixels from a starting pixel point.

28. A method as in claim 21, further comprising the step of:
providing an alert to said user after a selected alarm time period.

29. A method as in claim 21, further comprising the step of:
disabling said input device after a disable time period.

30. A method as in claim 21, further comprising the step of:
disabling said input device after an administrator selected disable time period.

31. A method as in claim 21, further comprising the step of:
adjusting said screen size to increase pointability.

32. A method as in claim 21, wherein said circle shaped colored indicator is translucent.

33. A method as in claim 21, wherein said circle shaped colored indicator is further comprised of displaying the destination of said Hyperlink translucently over said circle shaped colored indictor.

34. A method as in claim 21, wherein said period of inactivity is dynamically adaptable to the users proficiency.

35. A method as in claim 21, wherein said period of inactivity is configured by the end user, system administrator or domain host.

36. A method as in claim 21, further comprising the steps of:
providing a choreographed movement of said user-controlled pointer; and
performing a function on said choreographed movement by said user manipulated pointing device.

37. A system configured to select a graphical display element corresponding to an active region using a user-controlled pointing device, comprising:
a server side memory containing a document having non-resident code therein, said non-resident code configured to display an indicator when said user-controlled pointing device is pointing to an active region having a corresponding item and to actuate said pointing device after a period of inactivity to provide said corresponding item.

38. A system as in claim 37, wherein said non-resident code application is written in ActixeX.

39. A system as in claim 37, wherein said non-resident code application is written in Java script.

40. A system as in claim 37, wherein said corresponding item is selected from the group consisting of Hyperlinks, back icons, forward icons, save icons and scroll bars, search, email, print and other menu draw down and menu item selection functions.

41. A system as in claim 37, wherein said indicator is further comprised of a sound.

42. A system as in claim 37, wherein said period of inactivity is defined by the end user, a system administrator or domain host.

43. A system as in claim 37, wherein said program is programmed to reactivate when said user controlled pointer is moved in any direction beyond a defined number of pixels from a starting pixel point.

44. A system as in claim 37, wherein said program is programmed to disable said input device after a disable time period.

38. A system as in claim 37, wherein said program is programmed to adjust screen size to increase pointability in an area surrounding said pointer.

39. A system as in claim 37, wherein said indicator is translucent.

40. A system in claim 37, wherein said indicator is further comprised of the destination of said Hyperlink.
